(19) United States
(12) Patent Application Publication
(10) Pub. No.: US 2024/0055172 A1
(43) Pub. Date: Feb. 15, 2024

(54) POWER INDUCTOR DEVICE FOR AND MANUFACTURING METHOD THEREOF

(71) Applicant: TRIO Technology Co., Ltd. Seychelles Taiwan Branch, New Taipei City (TW)

(72) Inventors: Huo-Li LIN, New Taipei City (TW); Jin-Huo RAO, Hubei Province (CN); Ta-Wei WEI, Taichung City (TW)

(21) Appl. No.: 18/448,232

(22) Filed: Aug. 11, 2023

Related U.S. Application Data
(60) Provisional application No. 63/371,086, filed on Aug. 11, 2022.

(51) Int. Cl. H01F 27/255; H01F 41/02; H01F 27/26

(52) U.S. Cl. CPC H01F 27/255; H01F 41/0246; H01F 27/263

(57) ABSTRACT

A power inductor device and a manufacturing method thereof are provided. The power inductor device includes a first magnetic core body, a second magnetic core body, a third magnetic core body and a metal conductor. The first magnetic core body is formed by a first magnetic powder, the second magnetic core body is formed by a second magnetic powder and the third magnetic core body is formed by a third magnetic powder. The metal conductor is disposed between the columnar body and the groove. The first magnetic core body, the metal conductor, the second magnetic core body and the third magnetic core body are closely combined to obtain an integrated power inductor structure. The first magnetic powder, the second magnetic powder and the third magnetic powder include an iron-based magnetic powder having the large particle size, the medium particle size and the small particle size.

### CROSS-REFERENCE TO RELATED APPLICATION

This application claims the benefit of U.S. Provisional Application No. 63/371,086, filed Aug. 11, 2022, the disclosure of which is incorporated by reference herein in its entirety.

### BACKGROUND OF THE INVENTION

### 1. Field of the Invention

The present invention generally relates to a power inductor device and a manufacturing method thereof, and in particular, to the integrated power inductor having high intensity inductor with better inductance value and saturation current capability, and the manufacturing cost is low.

### 2. Description of the Related Art

Due to the continuous development of the electronic products, the functional requirements are getting higher and higher, and the requirements for superimposed current are also increasing. While pursuing high efficiency, the loss of the inductive powder materials is also getting smaller and smaller. The conventional inductor and the manufacturing method are not able to meet the functional requirements of the current electronic products.

The conventional inductor can be made by single magnetic powder or composite magnetic powder. The different kinds of the magnetic powder may affect the frequency of use, the loss of the material, the product performance and the magnetic saturation capability. The single magnetic material is not able to meet the requirements of the inductor product. The composite magnetic material may increase the inductance value. However, the production cost and the material loss are not easy to control, and the material density is also difficult to meet the requirements. Although some product uses pre-pressing process to increase the density, the final product still can not meet the specific specs.

In summary, the conventional power inductor device and the manufacturing method thereof still has considerable problems. Hence, the present disclosure provides the power inductor device and the manufacturing method thereof to resolve the shortcomings of conventional technology and promote industrial practicability.

### SUMMARY OF THE INVENTION

In view of the aforementioned technical problems, the primary objective of the present disclosure is to provide the power inductor device and the manufacturing method thereof, which are capable of improving the density of the inductor with better inductance value and saturation current capability, and also reducing production cost.

In accordance with one objective of the present disclosure, a power inductor device is provided. The power inductor device includes a first magnetic core body, a second magnetic core body, a third magnetic core body and a metal conductor. The first magnetic core body is formed by a first magnetic powder. The first magnetic core body includes a groove in a body base and two channels extended from the groove, wherein the two channels have height difference at side openings of the body base. The second magnetic core body is formed by a second magnetic powder. The second magnetic core body includes a columnar body disposed in the groove, wherein an accommodating space is generated between the columnar body and the groove. The third magnetic core body is formed by a third magnetic powder. The third magnetic core body includes a plate body and two channel notches corresponding to the two channels, wherein the plate body covers on the first magnetic core body and the second magnetic core body. The metal conductor is disposed in the accommodating space, and two ends of the metal conductor being are exposed outside the first magnetic core body through the side openings. The first magnetic core body, the second magnetic core body, the third magnetic core body and the metal conductor being closely combined by a heating and pressing molding process to obtain an integrated power inductor structure. Wherein the first magnetic powder, the second magnetic powder and the third magnetic powder include an iron-based magnetic powder mixed with an adhesive, the iron-based magnetic powder has a first particle size, a second particle size and a third particle size, the first particle size is smaller than the second particle size and the second particle size is smaller than the third particle size.

Preferably, the first particle size may be 10 nm-5 μm, the second particle size may be 8.5 μm-15 μm, and the third particle size may be 18 μm-35 μm.

Preferably, the iron-based magnetic powder may have 80%-98.5% of unit weight and the adhesive may have 1.5%-20% of unit weight.

Preferably, the iron-based magnetic powder may include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof.

Preferably, particle size of the carbonyl may be 3 μm-8 μm, particle size of the iron silicon chromium may be 3 μm-35 μm, particle size of the nanocrystalline alloy may be 19 μm-23 μm, particle size of the amorphous may be 13 μm-28 μm, particle size of the iron nickel may be 12 μm-16 μm, particle size of the MPP iron nickel molybdenum may be 11 μm-18 μm.

Preferably, the side openings may be disposed at same side of the body base, opposite side of the body base or adjacent side of the body base.

Preferably, the columnar body may include round shape, oval shape, rectangular shape or polygonal shape.

Preferably, the metal conductor may be made by gold, silver, copper, nickel or aluminum.

Preferably, the metal conductor may include a round coil or a flat coil, the metal conductor may be U shape, circle shape, ellipse shape, spiral shape, rectangular shape or I shape.

Preferably, heating temperature of the heating and pressing molding process may be 180° C.-300° C., forming pressure of the heating and pressing molding process may be 5-13 T/cm³ and full pressure time of the forming pressure may be 50 s-120 s.

In accordance with one objective of the present disclosure, manufacturing method of a power inductor device is provided. The manufacturing method includes following steps of: providing a first magnetic core body, a second magnetic core body, a third magnetic core body and a metal conductor, the first magnetic core body being formed by a first magnetic powder, the second magnetic core body being formed by a second magnetic powder and the third magnetic core body being formed by a third magnetic powder; assembling the first magnetic core body and the metal conductor, the metal conductor being placed in a groove of the first magnetic core body and two ends of the metal conductor being placed in two channels of the first magnetic core body, wherein the two ends of the metal conductor are exposed outside the first magnetic core body through side openings of a body base; placing the second magnetic core body in the grove, the second magnetic core body comprising a columnar body and the columnar body being inserted into hollow part of the metal conductor; placing the third magnetic core body on the first magnetic core body, the metal conductor and the second magnetic core body, the third magnetic core body comprising a plate body and the plate body covering on the first magnetic core body and the second magnetic core body; conducting a heating and pressing molding process to the first magnetic core body, the second magnetic core body, the third magnetic core body and the metal conductor to form an integrated power inductor structure; wherein the first magnetic powder, the second magnetic powder and the third magnetic powder include an iron-based magnetic powder mixed with an adhesive, the iron-based magnetic powder having a first particle size, a second particle size and a third particle size, the first particle size is smaller than the second particle size and the second particle size is smaller than the third particle size.

Preferably, the first particle size may be 10 nm-5 μm, the second particle size may be 8.5 μm-15 μm, and the third particle size may be 18 μm-35 μm.

Preferably, the iron-based magnetic powder may have 80%-98.5% of unit weight and the adhesive may have 1.5%-20% of unit weight.

Preferably, the iron-based magnetic powder may include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof.

Preferably, particle size of the carbonyl may be 3 μm-8 μm, particle size of the iron silicon chromium may be 3 μm-35 μm, particle size of the nanocrystalline alloy may be 19 μm-23 μm, particle size of the amorphous may be 13 μm-28 μm, particle size of the iron nickel may be 12 μm-16 μm, particle size of the MPP iron nickel molybdenum may be 11 μm-18 μm.

Preferably, the side openings may be disposed at same side of the body base, opposite side of the body base or adjacent side of the body base.

Preferably, the columnar body may include round shape, oval shape, rectangular shape or polygonal shape.

Preferably, the metal conductor may be made by gold, silver, copper, nickel or aluminum.

Preferably, the metal conductor may include a round coil or a flat coil, the metal conductor may be U shape, circle shape, ellipse shape, spiral shape, rectangular shape or I shape.

Preferably, heating temperature of the heating and pressing molding process may be 180° C.-300° C., forming pressure of the heating and pressing molding process may be 5-13 T/cm³ and full pressure time of the forming pressure may be 50 s-120 s.

As mentioned previously, the power inductor device and the manufacturing method thereof may have one or more advantages as follows.

1. The power inductor device and the manufacturing method thereof may improve the uniformity of the magnetic powder filling, increase the weight of the magnetic powder, reduce the air gap, increase the density and single weight of the final product, so as to effectively increase the inductance value.

2. The power inductor device and the manufacturing method thereof may use the pre-pressing process and the heating and pressing molding process to increase the density of the power inductor device. The forming pressure can reduce about, so as to significantly reduce mold loss, increase the service life and reduce the mold cost.

3. The power inductor device and the manufacturing method thereof may reduce the material cost and the production cost. The production yield has been greatly improved, and the product can be mass-produced by automatic apparatus.

### BRIEF DESCRIPTION OF THE DRAWINGS

The technical features, detail structures, advantages and effects of the present disclosure will be described in more details hereinafter with reference to the accompanying drawings that show various embodiments of the invention as follows.

FIG. 1 is schematic diagrams of the power inductor device and manufacturing method of the power inductor device in accordance with the first embodiment of the present disclosure.

FIG. 2 is schematic diagram of the power inductor device and manufacturing method of the power inductor device in accordance with the second embodiment of the present disclosure.

FIG. 3 is schematic diagrams of the power inductor device and manufacturing method of the power inductor device in accordance with the third embodiment of the present disclosure.

### DETAILED DESCRIPTION OF THE PREFERRED EMBODIMENTS

In order to facilitate the understanding of the technical features, the contents and the advantages of the present disclosure, and the effectiveness thereof that can be achieved, the present disclosure will be illustrated in detail below through embodiments with reference to the accompanying drawings. The diagrams used herein are merely intended to be schematic and auxiliary to the specification, but are not necessary to be true scale and precise to the configuration after implementing the present disclosure. Thus, it should not be interpreted in accordance with the scale and the configuration of the accompanying drawings to limit the scope of the present disclosure on the practical implementation.

As those skilled in the art would realize, the described embodiments may be modified in various different ways. The exemplary embodiments of the present disclosure are for explanation and understanding only. The drawings and description are to be regarded as illustrative in nature and not restrictive. Similar reference numerals designate similar elements throughout the specification.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

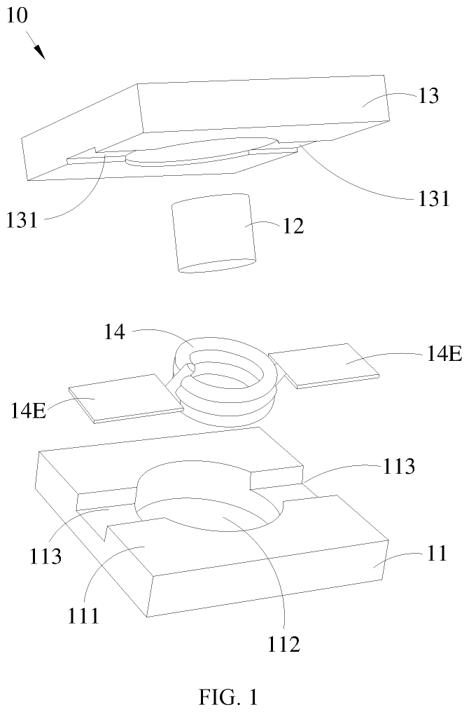

Please refer to FIG. 1, which is the schematic diagrams of the power inductor device and manufacturing method of the power inductor device in accordance with the first embodiment of the present disclosure.

As shown in FIG. 1, the power inductor device 10 includes a first magnetic core body 11, a second magnetic core body 12, a third magnetic core body 13 and a metal conductor 14. The first magnetic core body 11, the metal conductor 14, the second magnetic core body 12 and the third magnetic core body 13 are closely combined as an integrated power inductor structure. The first magnetic core body 11 includes a body base 111 and a groove 112 disposed in the body base 111. The groove 112 has two channels 113 extended from the groove 112, wherein the two channels 112 have height difference at side openings of the body base 111. As shown in the figure, the channel depth at left side is deeper than the channel depth at left side. The height difference is applicable to the height difference between two ends 14E of the metal conductor 14.

The second magnetic core body 12 is a columnar body structure. The columnar body structure can be disposed in the groove 112. When the second magnetic core body 12 is disposed in the groove 112, an accommodating space is generated between the columnar body and the groove 112. The metal conductor 14 is disposed in the accommodating space. Since the accommodating space is used to place the metal conductor 14, the columnar body can be different based on the different shapes of the metal conductors. For example, the columnar body may be round shape, oval shape, rectangular shape or polygonal shape. When the metal conductor 14 is disposed in the accommodating space, the two ends 14E of the metal conductor 14 are placed in the two channels 113. The two ends 14E of the metal conductor 14 are exposed outside the first magnetic core body 11 through the side openings of the body base 111.

After disposing the metal conductor 14 in the accommodating space between the columnar body and the groove 112, the third magnetic core body 13 is disposed on the first magnetic core body 11 and the second magnetic core body 12. The third magnetic core body 13 is a plate body structure. The dimension of the third magnetic core body 13 is corresponding to the size of the first magnetic core body 11. That is, the plate body may cover on the first magnetic core body 11 and the second magnetic core body 12. The third magnetic core body 13 has two channel notches 131 corresponding to the two channels 113. The two channel notches 131 covers the two ends 14E of the metal conductor 14. The channel depth is depending on the thickness of the metal conductor 14.

The first magnetic core body 11 is formed by a first magnetic powder, the second magnetic core body 12 is formed by a second magnetic powder and the third magnetic core body 13 is formed by a third magnetic powder. The first magnetic powder, the second magnetic powder and the third magnetic powder include an iron-based magnetic powder mixed with an adhesive. The iron-based magnetic powder has a first particle size, a second particle size and a third particle size, the first particle size is smaller than the second particle size and the second particle size is smaller than the third particle size. In the present embodiment, the first particle size may be 10 nm-5 μm, the second particle size may be 8.5 μm-15 μm, and the third particle size may be 18 μm-35 μm. The adhesive may be an organic resin, an epoxy resin or an aldehyde resin. In the present embodiment, the iron-based magnetic powder may have 80%-98.5% of unit weight and the adhesive may have 1.5%-20% of unit weight.

The iron-based magnetic powder may include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof. The particle size of the carbonyl may be 3 μm-8 μm, the particle size of the iron silicon chromium may be 3 μm-35 μm, the particle size of the nanocrystalline alloy may be 19 μm-23 μm, the particle size of the amorphous may be 13 μm-28 μm, the particle size of the iron nickel may be 12 μm-16 μm, the particle size of the MPP iron nickel molybdenum may be 11 μm-18 μm. As mentioned to the different particle sizes above, the carbonyl may choose 3, 5 or 7 μm particle, the iron silicon chromium may choose 11, 15, 18, 22, 25 or 30 μm particle, the nanocrystalline alloy may choose 19, 21 or 23 μm particle, the amorphous may choose 15, 18 or 22 μm particle, the iron nickel may choose 13 or 15 μm particle, the MPP iron nickel molybdenum may choose 13, 15 or 17 μm particle. The different sizes of particle can be used to meet the large, the medium and the small size range of the particles. By using the mixture of different particle sizes, the uniformity of the magnetic powder filling can be improved, the weight of the magnetic powder can be effectively increased, the air gap can be reduced, the density and single weight of the final product can be increased 3.5-8%, so as to effectively increase the inductance value about 2-6%.

The first magnetic powder, the second magnetic powder and the third magnetic powder may choose same or different iron-based magnetic powders for forming the magnetic core body. The iron-based magnetic powder may include more than one material. For example, the iron-based magnetic powder may include a first powder and a second powder, the first powder and the second powder have same or different materials selected from the above iron-based magnetic powders. The first powder has 5-95 weight of the iron-based magnetic powder and the second powder has 5-40 weight of the iron-based magnetic powder. In other embodiment, the iron-based magnetic powder may include a first powder, a second powder and a third powder, the first powder, the second powder and the third powder have same or different materials. The first powder has 5-40 weight of the iron-based magnetic powder, the second powder has 5-40 weight of the iron-based magnetic powder and the third powder has 20-90 weight of the iron-based magnetic powder.

The metal conductor 14 can be made by gold, silver, copper, nickel or aluminum. The metal conductor 14 is a round coil with round winding in circle shape. The coil number is determined by the product specs. In other embodiment, the metal conductor 14 may be a flat coil, and the metal conductor may be U shape, ellipse shape, spiral shape, rectangular shape or I shape. The metal conductor 14 has a hollow part corresponding to the second magnetic core body 12. The metal conductor 14 has two ends 14E, one is extended from the upper part at left side of the coil and the other one is extended from the bottom part at right side of the coil. The two ends 14E of the metal conductor 14 are extended to opposite side of the body base 111 and are exposed outside the first magnetic core body 11 through the opposite side openings. However, the present disclosure is not limited in this structure. When the two ends 14E of the metal conductor 14 are designed toward the same direction or the perpendicular direction, the side openings may be correspondingly disposed at the same side of the body base 111 or the adjacent side of the body base 111. The detail manufacturing method of forming the power inductor device 10 will be described as follows.

Please refer to FIG. 1, the manufacturing method provides the first magnetic core body 11, the first magnetic core body 11 is formed by the first magnetic powder. The first magnetic powder includes the at least one iron-based magnetic powder mixed with the adhesive, and the at least one iron-based magnetic powder has large particle size, medium particle size and small particle size powders. The mixture of the iron-based magnetic powder and the adhesive are pre-pressed to form the base 111, the groove 112 and the two channels 113. Similarly, the manufacturing method provides the second magnetic core body 12, the second magnetic core body 11 is formed by the second magnetic powder. The second magnetic powder includes the at least one iron-based magnetic powder mixed with the adhesive, and the at least one iron-based magnetic powder has large particle size, medium particle size and small particle size powders. The mixture of the iron-based magnetic powder and the adhesive are pre-pressed to form the columnar body structure. At last, the manufacturing method provides the third magnetic core body 13, the third magnetic core body 13 is formed by the third magnetic powder. The third magnetic powder includes the at least one iron-based magnetic powder mixed with the adhesive, and the at least one iron-based magnetic powder has large particle size, medium particle size and small particle size powders. The mixture of the iron-based magnetic powder and the adhesive are pre-pressed to form the plate body structure. In the pre-press process, the first magnetic core body 11, the second magnetic core body 12 and the third magnetic core body 13 can be cured by heat. However, the present disclosure is not limited to this. In other embodiment, the first magnetic core body 11, the second magnetic core body 12 and the third magnetic core body 13 are provided without curing process.

After forming the first magnetic core body 11, the second magnetic core body 12 and the third magnetic core body 13, the manufacturing method provides metal conductor 14. The metal conductor 14 is made by the round coil with the hollow part in the middle. The two ends 14E are extended from the upper part and the bottom part of the coil. The metal conductor 14 is placed in the groove 112 of the first magnetic core body 11 and the two ends 14E of the metal conductor 14 are placed in the two channels 113.

Since the first magnetic core body 11 and metal conductor 14 are assemble, the assembly parts are placed into a mold. Afterward, the second magnetic core body 12 is inserted into hollow part of the metal conductor 14 and the third magnetic core body 13 is placed on the first magnetic core body 11 and the second magnetic core body 12. The plate body structure of the third magnetic core body 13 covers the first magnetic core body 11 and the second magnetic core body 12. After assembling the first magnetic core body 11, the metal conductor 14, the second magnetic core body 12 and the third magnetic core body 13, the heating and pressing molding process is conducted to form an integrated power inductor structure.

The heating and pressing molding process is conducted to the mold. The heating temperature of the heating and pressing molding process may be 180° C.-300° C., the forming pressure of the heating and pressing molding process may be 5-13 T/cm³ and the full pressure time of the forming pressure may be 50 s-120 s. After heating and pressing molding process, the power inductor device 10 with the integrated power inductor structure is obtained. Since the magnetic core body is formed by the pre-pressing process and the heating and pressing molding process is used, the magnetic powder is closely combined to increase the density of the device. In addition, the forming pressure can reduce about 30%, so as to significantly reduce mold loss, increase the service life and reduce the mold cost. The device body will not break or crack when releasing from the mold. The production yield has been greatly improved, and the product can be mass-produced by automatic apparatus.

The first magnetic core body 11, the metal conductor 14, the second magnetic core body 12 and the third magnetic core body 13 are closely combined to obtain an integrated power inductor structure. The two ends 14E may further conduct the electroplating process to form the electro pads or pins.

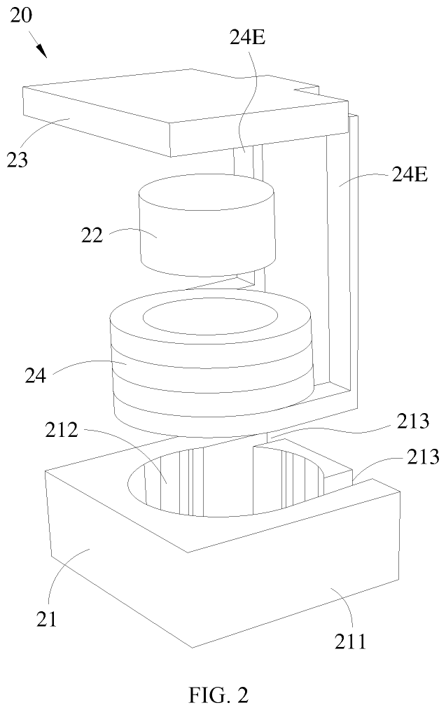

Please refer to FIG. 2, which is the schematic diagram of the power inductor device and manufacturing method of the power inductor device in accordance with the second embodiment of the present disclosure.

As shown in FIG. 2, the power inductor device 20 includes a first magnetic core body 21, a second magnetic core body 22, a third magnetic core body 23 and a metal conductor 24. The first magnetic core body 21, the metal conductor 24, the second magnetic core body 22 and the third magnetic core body 23 are closely combined as an integrated power inductor structure. The first magnetic core body 21 includes a body base 211 and a groove 212 disposed in the body base 111. The groove 212 has two channels 113 extended from the groove 212, wherein the two channels 212 have height difference at side openings of the body base 211. The height difference is applicable to the height difference between two ends 24E of the metal conductor 24. As shown in the figure, the difference from previous embodiment is that the two channels 213 are disposed on same side of body base 211.

The second magnetic core body 22 is a columnar body structure. The columnar body structure can be disposed in the groove 212. When the second magnetic core body 22 is disposed in the groove 212, an accommodating space is generated between the columnar body and the groove 212. The metal conductor 24 is disposed in the accommodating space. Since the accommodating space is used to place the metal conductor 24, the columnar body can be different based on the different shapes of the metal conductors. For example, the columnar body may be round shape, oval shape, rectangular shape or polygonal shape. When the metal conductor 24 is disposed in the accommodating space, the two ends 24E of the metal conductor 24 are placed in the two channels 213. The two ends 24E of the metal conductor 24 are exposed outside the first magnetic core body 21 through the side openings of the body base 211.

After disposing the metal conductor 24 in the accommodating space between the columnar body and the groove 212, the third magnetic core body 23 is disposed on the first magnetic core body 21 and the second magnetic core body 22. The third magnetic core body 23 is a plate body structure. The dimension of the third magnetic core body 23 is corresponding to the size of the first magnetic core body 21. That is, the plate body may cover on the first magnetic core body 21 and the second magnetic core body 22. The third magnetic core body 23 may has two channel notches corresponding to the two channels 213. The two channel notches cover the two ends 24E of the metal conductor 24. In the present embodiment, the two channel notches are disposed on same side of the plate body.

The first magnetic core body 21 is formed by a first magnetic powder, the second magnetic core body 22 is formed by a second magnetic powder and the third magnetic core body 23 is formed by a third magnetic powder. The first magnetic powder, the second magnetic powder and the third magnetic powder include an iron-based magnetic powder mixed with an adhesive. The iron-based magnetic powder has a first particle size, a second particle size and a third particle size, the first particle size is smaller than the second particle size and the second particle size is smaller than the third particle size. In the present embodiment, the first particle size may be 10 nm-5 μm, the second particle size may be 8.5 μm-15 μm, and the third particle size may be 18 μm-35 μm. The adhesive may be an organic resin, an epoxy resin or an aldehyde resin. In the present embodiment, the iron-based magnetic powder may have 80%-98.5% of unit weight and the adhesive may have 1.5%-20% of unit weight.

The iron-based magnetic powder may include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof. The particle size of the carbonyl may be 3 μm-8 μm, the particle size of the iron silicon chromium may be 3 μm-35 μm, the particle size of the nanocrystalline alloy may be 19 μm-23 μm, the particle size of the amorphous may be 13 μm-28 μm, the particle size of the iron nickel may be 12 μm-16 μm, the particle size of the MPP iron nickel molybdenum may be 11 μm-18 μm. As mentioned to the different particle sizes above, the carbonyl may choose 3, 5 or 7 μm particle, the iron silicon chromium may choose 11, 15, 18, 22, 25 or 30 μm particle, the nanocrystalline alloy may choose 19, 21 or 23 μm particle, the amorphous may choose 15, 18 or 22 μm particle, the iron nickel may choose 13 or 15 μm particle, the MPP iron nickel molybdenum may choose 13, 15 or 17 μm particle. The different sizes of particle can be used to meet the large, the medium and the small size range of the particles. By using the mixture of different particle sizes, the uniformity of the magnetic powder filling can be improved, the weight of the magnetic powder can be effectively increased, the air gap can be reduced, the density and single weight of the final product can be increased 3.5-8%, so as to effectively increase the inductance value about 2-6%.

The first magnetic powder, the second magnetic powder and the third magnetic powder may choose same or different iron-based magnetic powders for forming the magnetic core body. The iron-based magnetic powder may include more than one material. For example, the iron-based magnetic powder may include a first powder and a second powder, the first powder and the second powder have same or different materials selected from the above iron-based magnetic powders. The first powder has 5-95 weight of the iron-based magnetic powder and the second powder has 5-40 weight of the iron-based magnetic powder. In other embodiment, the iron-based magnetic powder may include a first powder, a second powder and a third powder, the first powder, the second powder and the third powder have same or different materials. The first powder has 5-40 weight of the iron-based magnetic powder, the second powder has 5-40 weight of the iron-based magnetic powder and the third powder has 20-90 weight of the iron-based magnetic powder.

The metal conductor 24 can be made by gold, silver, copper, nickel or aluminum. The metal conductor 24 is a flat coil with round winding in circle shape. The coil number is determined by the product specs. In other embodiment, the metal conductor 24 may be a round coil, and the metal conductor may be U shape, ellipse shape, spiral shape, rectangular shape or I shape. The metal conductor 24 has a hollow part corresponding to the second magnetic core body 22. The metal conductor 24 has two ends 24E, one is extended from the upper part of the coil and the other one is extended from the bottom part of the coil. The two ends 24E of the metal conductor 24 are extended to same side of the body base 211 and are exposed outside the first magnetic core body 21 through the opposite side openings. However, the present disclosure is not limited in this structure. When the two ends 24E of the metal conductor 24 are designed toward the opposite direction or the perpendicular direction, the side openings may be correspondingly disposed at the opposite side of the body base 211 or the adjacent side of the body base 211. The detail manufacturing method of forming the power inductor device 20 will be described as follows.

Please refer to FIG. 2, the manufacturing method provides the first magnetic core body 21, the second magnetic core body 22 and the third magnetic core body 23. The first magnetic core body 21 is formed by the first magnetic powder. The first magnetic powder includes the at least one iron-based magnetic powder mixed with the adhesive, and the at least one iron-based magnetic powder has large particle size, medium particle size and small particle size powders. Similarly, the second magnetic core body 22 is formed by the second magnetic powder. The second magnetic powder includes the at least one iron-based magnetic powder mixed with the adhesive, and the at least one iron-based magnetic powder has large particle size, medium particle size and small particle size powders. The third magnetic core body 23 is formed by the third magnetic powder. The third magnetic powder includes the at least one iron-based magnetic powder mixed with the adhesive, and the at least one iron-based magnetic powder has large particle size, medium particle size and small particle size powders. In the present embodiment, the first magnetic powder, the second magnetic powder and the third magnetic powder are pre-pressed to form the structure of three core bodies. However, the first magnetic core body 21, the second magnetic core body 22 and the third magnetic core body 23 can be provided without the pre-pressing process. That is, the first magnetic powder, the second magnetic powder and the third magnetic powder can be directly put into the mold for the heating and pressing molding process.

In the present embodiment, the first magnetic core body 21 is provided by the first magnetic powder and the first magnetic core body 21 is placed into the mold. The manufacturing method provides metal conductor 24. The metal conductor 24 is made by the flat coil with the hollow part in the middle. The two ends 24E are extended from the upper part and the bottom part of the coil. The metal conductor 24 is put into the mold and is placed on the first magnetic core body 21. That is, the metal conductor 24 is disposed in the groove 212 and the two ends 24E of the metal conductor 24 are disposed in the two channels 213. Afterward, the second magnetic core body 22 is put into the mold. The columnar body of the second magnetic core body 22 is inserted in the hollow part of the metal conductor 24. At last, the third magnetic core body 23 is put into the mold. The plate body of the third magnetic core body 23 covers the first magnetic core body 21 and the second magnetic core body 22. The two ends 24E of the metal conductor 24 are extended in the same direction and are exposed from one side surfaces of the first magnetic core body 21 and the third magnetic core body 22. In the present embodiment, the two ends 24E of the metal conductor 24 can be bended toward the top surface of the third magnetic core body 23. After placing the third magnetic core body 23, the two ends 24E of the metal conductor 24 can be bended again to place on the top surface of the plate body. The two ends 24E of the metal conductor 24 can be used as the electro pads or pins disposed on the top surface of the plate body.

When the first magnetic core body 21, the metal conductor 24, the second magnetic core body 22 and the third magnetic core body 23 are put in the mold, the heating and pressing molding process is conducted to the mold. The heating temperature of the heating and pressing molding process may be 180° C.-300° C., the forming pressure of the heating and pressing molding process may be 5-13 T/cm³ and the full pressure time of the forming pressure may be 50 s-120 s. After heating and pressing molding process, the power inductor device 20 with the integrated power inductor structure is obtained. Since the magnetic core body is formed by the heating and pressing molding process is used, the magnetic powder is closely combined to increase the density of the device. In addition, the forming pressure can reduce about 30%, so as to significantly reduce mold loss, increase the service life and reduce the mold cost. The device body will not break or crack when releasing from the mold. The production yield has been greatly improved, and the product can be mass-produced by automatic apparatus.

The first magnetic core body 21, the metal conductor 24, the second magnetic core body 22 and the third magnetic core body 23 are closely combined to obtain an integrated power inductor structure. The power inductor device 20 may further include an insulation layer, the insulation layer covers outside surface of the first magnetic core body 21 and the third magnetic core body 23. The insulation layer may be formed by spray painting. After the spray painting process, the laser stripping process and the electroplating treatment are conducted to remove the paint and to expose the two ends 24E of the metal conductor 24. The two ends 24E may further conduct the electroplating process to form the electro pads or pins.

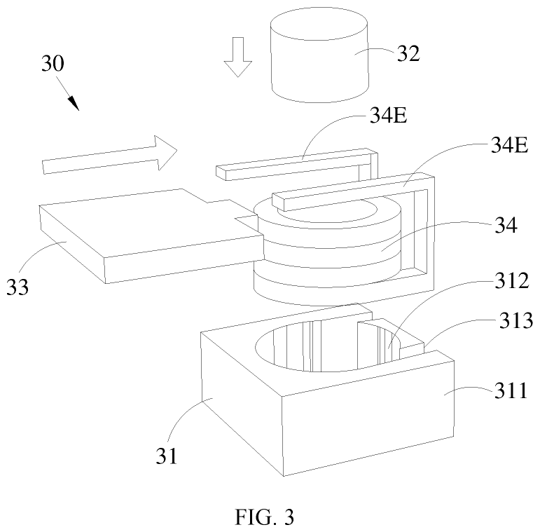

Please refer to FIG. 3, which is schematic diagrams of the power inductor device and manufacturing method of the power inductor device in accordance with the third embodiment of the present disclosure.

As shown in FIG. 3, the power inductor device 30 includes a first magnetic core body 31, a second magnetic core body 32, a third magnetic core body 33 and a metal conductor 34. The first magnetic core body 31, the metal conductor 34, the second magnetic core body 32 and the third magnetic core body 33 are closely combined as an integrated power inductor structure. The first magnetic core body 31 includes a body base 311 and a groove 312 disposed in the body base 311. The groove 312 has two channels 313 extended from the groove 312, wherein the two channels 312 have height difference at side openings of the body base 311. The height difference is applicable to the height difference between two ends 34E of the metal conductor 34. As shown in the figure, the two channels 313 are disposed on same side of body base 211.

The second magnetic core body 32 is a columnar body structure. The columnar body structure can be disposed in the groove 312. When the second magnetic core body 32 is disposed in the groove 312, an accommodating space is generated between the columnar body and the groove 312. The metal conductor 34 is disposed in the accommodating space. Since the accommodating space is used to place the metal conductor 34, the columnar body can be different based on the different shapes of the metal conductors. For example, the columnar body may be round shape, oval shape, rectangular shape or polygonal shape. When the metal conductor 34 is disposed in the accommodating space, the two ends 34E of the metal conductor 34 are placed in the two channels 313. The two ends 34E of the metal conductor 34 are exposed outside the first magnetic core body 31 through the side openings of the body base 311.

After disposing the metal conductor 34 in the accommodating space between the columnar body and the groove 312, the third magnetic core body 33 is disposed on the first magnetic core body 31 and the second magnetic core body 32. The third magnetic core body 33 is a plate body structure. The dimension of the third magnetic core body 33 is corresponding to the size of the first magnetic core body 31. That is, the plate body may cover on the first magnetic core body 31 and the second magnetic core body 32. The third magnetic core body 33 may has two channel notches corresponding to the two channels 313. The two channel notches cover the two ends 34E of the metal conductor 34. In the present embodiment, the two channel notches are disposed on same side of the plate body.

The first magnetic core body 31 is formed by a first magnetic powder, the second magnetic core body 32 is formed by a second magnetic powder and the third magnetic core body 33 is formed by a third magnetic powder. The first magnetic powder, the second magnetic powder and the third magnetic powder include an iron-based magnetic powder mixed with an adhesive. The iron-based magnetic powder has a first particle size, a second particle size and a third particle size, the first particle size is smaller than the second particle size and the second particle size is smaller than the third particle size. In the present embodiment, the first particle size may be 10 nm-5 μm, the second particle size may be 8.5 μm-15 μm, and the third particle size may be 18 μm-35 μm. The adhesive may be an organic resin, an epoxy resin or an aldehyde resin. In the present embodiment, the iron-based magnetic powder may have 80%-98.5% of unit weight and the adhesive may have 1.5%-20% of unit weight.

The iron-based magnetic powder may include carbonyl (CIP), iron silicon chromium (Fe—Si—Cr), iron silicon aluminum (Fe—Si—Al), iron silicon (Fe—Si), amorphous, nanocrystalline alloy, iron nickel (FeNi), MPP iron nickel molybdenum (FeNiMo—C), silicon (Si), iron cobalt nickel (Fe—Co—Ni), manganese zinc (MnZn), nickel zinc (NiZn) or a combination thereof. The particle size of the carbonyl may be 3 μm-8 μm, the particle size of the iron silicon chromium may be 3 μm-35 μm, the particle size of the nanocrystalline alloy may be 19 μm-23 μm, the particle size of the amorphous may be 13 μm-28 μm, the particle size of the iron nickel may be 12 μm-16 μm, the particle size of the MPP iron nickel molybdenum may be 11 μm-18 μm. As mentioned to the different particle sizes above, the carbonyl may choose 3, 5 or 7 μm particle, the iron silicon chromium may choose 11, 15, 18, 22, 25 or 30 μm particle, the nanocrystalline alloy may choose 19, 21 or 23 μm particle, the amorphous may choose 15, 18 or 22 μm particle, the iron nickel may choose 13 or 15 μm particle, the MPP iron nickel molybdenum may choose 13, 15 or 17 μm particle. The different sizes of particle can be used to meet the large, the medium and the small size range of the particles. By using the mixture of different particle sizes, the uniformity of the magnetic powder filling can be improved, the weight of the magnetic powder can be effectively increased, the air gap can be reduced, the density and single weight of the final product can be increased 3.5-8%, so as to effectively increase the inductance value about 2-6%.

The first magnetic powder, the second magnetic powder and the third magnetic powder may choose same or different iron-based magnetic powders for forming the magnetic core body. The iron-based magnetic powder may include more than one material. For example, the iron-based magnetic powder may include a first powder and a second powder, the first powder and the second powder have same or different materials selected from the above iron-based magnetic powders. The first powder has 5-95 weight of the iron-based magnetic powder and the second powder has 5-40 weight of the iron-based magnetic powder. In other embodiment, the iron-based magnetic powder may include a first powder, a second powder and a third powder, the first powder, the second powder and the third powder have same or different materials. The first powder has 5-40 weight of the iron-based magnetic powder, the second powder has 5-40 weight of the iron-based magnetic powder and the third powder has 20-90 weight of the iron-based magnetic powder.

The metal conductor 34 can be made by gold, silver, copper, nickel or aluminum. The metal conductor 34 is a flat coil with round winding in circle shape. The coil number is determined by the product specs. In other embodiment, the metal conductor 34 may be a round coil, and the metal conductor may be U shape, ellipse shape, spiral shape, rectangular shape or I shape. The metal conductor 34 has a hollow part corresponding to the second magnetic core body 32. The metal conductor 34 has two ends 34E, one is extended from the upper part of the coil and the other one is extended from the bottom part of the coil. The two ends 34E of the metal conductor 34 are extended through the two channels 312. The two ends 34E of the metal conductor 34 are extended to same side of the body base 311 and are exposed outside the first magnetic core body 31 through the opposite side openings. However, the present disclosure is not limited in this structure. When the two ends 34E of the metal conductor 34 are designed toward the opposite direction or the perpendicular direction, the side openings may be correspondingly disposed at the opposite side of the body base 311 or the adjacent side of the body base 311. The detail manufacturing method of forming the power inductor device 30 will be described as follows.

Please refer to FIG. 4, the manufacturing method provides the first magnetic core body 31, the second magnetic core body 32 and the third magnetic core body 33. The first magnetic core body 31 is formed by the first magnetic powder. The first magnetic powder includes the at least one iron-based magnetic powder mixed with the adhesive, and the at least one iron-based magnetic powder has large particle size, medium particle size and small particle size powders. Similarly, the second magnetic core body 32 is formed by the second magnetic powder. The second magnetic powder includes the at least one iron-based magnetic powder mixed with the adhesive, and the at least one iron-based magnetic powder has large particle size, medium particle size and small particle size powders. The third magnetic core body 33 is formed by the third magnetic powder. The third magnetic powder includes the at least one iron-based magnetic powder mixed with the adhesive, and the at least one iron-based magnetic powder has large particle size, medium particle size and small particle size powders. In the present embodiment, the first magnetic powder, the second magnetic powder and the third magnetic powder are pre-pressed to form the structure of three core bodies. However, the first magnetic core body 31, the second magnetic core body 32 and the third magnetic core body 33 can be provided without the pre-pressing process. That is, the first magnetic powder, the second magnetic powder and the third magnetic powder can be directly put into the mold for the heating and pressing molding process.

In the present embodiment, the first magnetic core body 31 is provided by the first magnetic powder and the first magnetic core body 31 is placed into the mold. The manufacturing method provides metal conductor 34. The metal conductor 34 is made by the flat coil with the hollow part in the middle. The two ends 34E are extended from the upper part and the bottom part of the coil. The metal conductor 34 is put into the mold and is placed on the first magnetic core body 31. That is, the metal conductor 34 is disposed in the groove 312 and the two ends 34E of the metal conductor 34 are disposed in the two channels 313. Afterward, the second magnetic core body 32 is put into the mold. The columnar body of the second magnetic core body 32 is inserted in the hollow part of the metal conductor 34. The difference from the previous embodiment is that the two ends 34E of the metal conductor 34 are bended twice toward the first magnetic core body 31 and the two ends 34E of the metal conductor 34 are opposite to the channel openings. In the present embodiment, the two ends are bended and facing the horizontal direction. At last, the third magnetic core body 33 is put into the mold. The plate body of the third magnetic core body 33 is inserted to the space between the coil and the bended end of the coil. The plate body covers the first magnetic core body 31 and the second magnetic core body 32.

When the first magnetic core body 31, the second magnetic core body 32, the third magnetic core body 33 and the metal conductor 34 are assembled and put in the mold, the heating and pressing molding process is conducted to the mold. The heating temperature of the heating and pressing molding process may be 180° C.-300° C., the forming pressure of the heating and pressing molding process may be 5-13 T/cm³ and the full pressure time of the forming pressure may be 50 s-120 s. After heating and pressing molding process, the power inductor device 30 with the integrated power inductor structure is obtained. Since the magnetic core body is formed by the heating and pressing molding process is used, the magnetic powder is closely combined to increase the density of the device. In addition, the forming pressure can reduce about 30%, so as to significantly reduce mold loss, increase the service life and reduce the mold cost. The device body will not break or crack when releasing from the mold. The production yield has been greatly improved, and the product can be mass-produced by automatic apparatus.

The first magnetic core body 31, the metal conductor 34, the second magnetic core body 32 and the third magnetic core body 33 are closely combined to obtain an integrated power inductor structure. The power inductor device 30 may further include an insulation layer, the insulation layer covers outside surface of the first magnetic core body 31 and the second magnetic core body 32. The insulation layer may be formed by spray painting. After the spray painting process, the laser stripping process and the electroplating treatment are conducted to remove the paint and to expose the two ends 34E of the metal conductor 34. The two ends 34E may further conduct the electroplating process to form the electro pads or pins.

The above embodiments provide several examples to the power inductor device. However, the present disclosure is not limited to this. In other embodiments, the shape or the numbers of the magnetic core body and the metal conductor can be different. The design can be decided by the requirements of the electronic components.

The present disclosure disclosed herein has been described by means of specific embodiments. However, numerous modifications, variations and enhancements can be made thereto without departing from the spirit and scope of the disclosure set forth in the claims.

What is claimed is:

1. A power inductor device comprising:
a first magnetic core body formed by a first magnetic powder, the first magnetic core body comprising a groove in a body base and two channels extended from the groove, wherein the two channels have height difference at side openings of the body base;
a second magnetic core body formed by a second magnetic powder, the second magnetic core body comprising a columnar body disposed in the groove, wherein an accommodating space is generated between the columnar body and the groove;
a third magnetic core body formed by a third magnetic powder, the third magnetic core body comprising a plate body and two channel notches corresponding to the two channels, wherein the plate body covers on the first magnetic core body and the second magnetic core body; and
a metal conductor disposed in the accommodating space, and two ends of the metal conductor being exposed outside the first magnetic core body through the side openings, the first magnetic core body, the second magnetic core body, the third magnetic core body and the metal conductor being closely combined by a heating and pressing molding process to obtain an integrated power inductor structure;
wherein the first magnetic powder, the second magnetic powder and the third magnetic powder comprise an iron-based magnetic powder mixed with an adhesive, the iron-based magnetic powder having a first particle size, a second particle size and a third particle size, the first particle size is smaller than the second particle size and the second particle size is smaller than the third particle size.

2. The power inductor device of claim 1, wherein the first particle size is 10 nm-5 μm, the second particle size is 8.5 μm-15 μm, and the third particle size is 18 μm-35 μm.

3. The power inductor device of claim 1, wherein the iron-based magnetic powder has 80%-98.5% of unit weight and the adhesive has 1.5%-20% of unit weight.

4. The power inductor device of claim 1, wherein the iron-based magnetic powder comprises carbonyl, iron silicon chromium, iron silicon aluminum, iron silicon, amorphous, nanocrystalline alloy, iron nickel, MPP iron nickel molybdenum, silicon, iron cobalt nickel, manganese zinc, nickel zinc or a combination thereof.

5. The power inductor device of claim 4, wherein particle size of the carbonyl is 3 μm-8 μm, particle size of the iron silicon chromium is 3 μm-35 μm, particle size of the nanocrystalline alloy is 19 μm-23 μm, particle size of the amorphous is 13 μm-28 μm, particle size of the iron nickel is 12 μm-16 μm, particle size of the MPP iron nickel molybdenum is 11 μm-18 μm.

6. The power inductor device of claim 1, wherein the side openings are disposed at same side of the body base, opposite side of the body base or adjacent side of the body base.

7. The power inductor device of claim 1, wherein the columnar body comprises round shape, oval shape, rectangular shape or polygonal shape.

8. The power inductor device of claim 1, wherein the metal conductor is made by gold, silver, copper, nickel or aluminum.

9. The power inductor device of claim 1, wherein the metal conductor comprises a round coil or a flat coil, the metal conductor is U shape, circle shape, ellipse shape, spiral shape, rectangular shape or I shape.

10. The power inductor device of claim 1, wherein heating temperature of the heating and pressing molding process is 180° C.-300° C., forming pressure of the heating and pressing molding process is 5-13 T/cm³ and full pressure time of the forming pressure is 50 s-120 s.

11. A manufacturing method of a power inductor device, the manufacturing method comprising following steps of:
providing a first magnetic core body, a second magnetic core body, a third magnetic core body and a metal conductor, the first magnetic core body being formed by a first magnetic powder, the second magnetic core body being formed by a second magnetic powder and the third magnetic core body being formed by a third magnetic powder;
assembling the first magnetic core body and the metal conductor, the metal conductor being placed in a groove of the first magnetic core body and two ends of the metal conductor being placed in two channels of the first magnetic core body, wherein the two ends of the metal conductor are exposed outside the first magnetic core body through side openings of a body base;
placing the second magnetic core body in the grove, the second magnetic core body comprising a columnar body and the columnar body being inserted into hollow part of the metal conductor;
placing the third magnetic core body on the first magnetic core body, the metal conductor and the second magnetic core body, the third magnetic core body comprising a plate body and the plate body covering on the first magnetic core body and the second magnetic core body;
conducting a heating and pressing molding process to the first magnetic core body, the second magnetic core body, the third magnetic core body and the metal conductor to form an integrated power inductor structure;
wherein the first magnetic powder, the second magnetic powder and the third magnetic powder comprise an iron-based magnetic powder mixed with an adhesive, the iron-based magnetic powder having a first particle size, a second particle size and a third particle size, the first particle size is smaller than the second particle size and the second particle size is smaller than the third particle size.

12. The manufacturing method of claim 11, wherein the first particle size is 10 nm-5 μm, the second particle size is 8.5 μm-15 μm, and the third particle size is 18 μm-35 μm.

13. The manufacturing method of claim 11, wherein the iron-based magnetic powder has 80%-98.5% of unit weight and the adhesive has 1.5%-20% of unit weight.

14. The manufacturing method of claim 11, wherein the iron-based magnetic powder comprises carbonyl, iron silicon chromium, iron silicon aluminum, iron silicon, amorphous, nanocrystalline alloy, iron nickel, MPP iron nickel molybdenum, silicon, iron cobalt nickel, manganese zinc, nickel zinc or a combination thereof.

15. The manufacturing method of claim 14, wherein particle size of the carbonyl is 3 μm-8 μm, particle size of the iron silicon chromium is 3 μm-35 μm, particle size of the nanocrystalline alloy is 19 μm-23 μm, particle size of the amorphous is 13 μm-28 μm, particle size of the iron nickel is 12 μm-16 μm, particle size of the MPP iron nickel molybdenum is 11 μm-18 μm.

16. The manufacturing method of claim 11, wherein the side openings are disposed at same side of the body base, opposite side of the body base or adjacent side of the body base.

17. The manufacturing method of claim 11, wherein the columnar body comprises round shape, oval shape, rectangular shape or polygonal shape.

18. The manufacturing method of claim 11, wherein the metal conductor is made by gold, silver, copper, nickel or aluminum.

19. The manufacturing method of claim 11, wherein the metal conductor comprises a round coil or a flat coil, the metal conductor is U shape, circle shape, ellipse shape, spiral shape, rectangular shape or I shape.

20. The manufacturing method of claim 11, wherein heating temperature of the heating and pressing molding process is 180° C.-300° C., forming pressure of the heating and pressing molding process is 5-13 T/cm³ and full pressure time of the forming pressure is 50 s-120 s.
